(19) United States
(12) Patent Application Publication
(10) Pub. No.: US 2026/0149908 A1
(43) Pub. Date: May 28, 2026

(54) EARPHONE DEVICE

(71) Applicant: Audio-Technica Corporation, Tokyo (JP)

(72) Inventor: Yuya YAMAGAMI, Tokyo (JP)

(21) Appl. No.: 19/122,030

(22) PCT Filed: Aug. 7, 2023
(86) PCT No.: PCT/JP2023/028707

§ 371 Date: Apr. 17, 2025

(30) Foreign Application Priority Data
Oct. 27, 2022 (JP) 2022-172665

(51) Int. Cl. H04R 1/10

(52) U.S. Cl. CPC H04R 1/1016

(57) ABSTRACT

Provided is an earphone device that enables desired functions without causing stress to users when the device is worn in an ear. The earphone device includes a sound emitting unit to be worn in the user's ear. The unit includes an antenna receiving an audio signal, a driver unit driven by the audio signal received by the antenna, and a battery storing power for the antenna. The battery is charged with the unit accommodated in a charger. The unit is inactive with the unit accommodated in the charger and active with the unit removed from the charger. The unit in the active state includes first and second operating modes. When a state of the unit is switched from the inactive state to the active state, the operating mode of the unit for a predetermined time after the switching is the first operating mode.

### Technical Field

The present invention relates to an earphone device.

### Background Art

An earphone device is worn on an ear of a user, and outputs a sound wave corresponding to an audio signal from a sound source such as a portable terminal including a smartphone and a portable musical sound player. Small and multifunctional products for earphone devices are increasing. For wireless earphones, fully wireless earphones in which left and right sound emitting units are not physically connected to each other with a cable or the like have become widespread in recent years (for example, see PTL 1). Fully wireless earphones receive an audio signal from a sound source via a wireless communication line such as Bluetooth (registered trademark), for example.

Among fully wireless earphones, for example, fully wireless earphones having a noise canceling function are known (for example, see PTL 2). The noise canceling function of the fully wireless earphones is enabled at a timing at which the fully wireless earphones are activated, for example. When one of sound emitting units of the fully wireless earphones is worn on one ear in a state in which the noise canceling function is enabled, a sound in which an external sound is silenced by the noise canceling function is heard in the ear. Meanwhile, the external sound is heard in the other ear on which the other sound emitting unit of the fully wireless earphones is not worn. Thus, a user feels a sense of discomfort and stress due to a difference in sound between both ears.

Among fully wireless earphones, for example, there are fully wireless earphones in which the noise canceling function is enabled by operating a control switch. Since a fully wireless earphone has a size to an extent that fits in an auricle, the control switch arranged on the fully wireless earphone is small and an operation method also needs to be simple. A user operates the control switch close to an ear without visual check, and thus accidental operation often occurs. Meanwhile, among fully wireless earphones, there are also fully wireless earphones that detect presence or absence of wearing by a wearing sensor (such as an IR sensor and a capacitance sensor) and switch the noise canceling function to be enabled. However, in the fully wireless earphones including the wearing sensor, malfunction in such a manner that the wearing sensor does not respond due to an individual difference and the wearing sensor responds when the fully wireless earphones are put in a pocket of clothing may occur.

### CITATION LIST

### Patent Literature

PTL 1JP 2020-039243 A

PTL 2JP 2012-023637 A

### SUMMARY OF INVENTION

### Technical Problem The present invention is directed to enabling an earphone device to perform desired functions when the earphone device is worn in an ear.

### Solution to Problem

An earphone device according to one aspect of the present invention includes a sound emitting unit to be worn in an ear of a user, in which the sound emitting unit includes an antenna that receives an audio signal, a driver unit that is driven based on the audio signal received by the antenna, and a battery that stores power supplied to the antenna, the battery is charged when the sound emitting unit is accommodated in a charger, the sound emitting unit is in an inactive state when the sound emitting unit is accommodated in the charger, and is in an active state when the sound emitting unit is not accommodated in the charger, an operating mode of the sound emitting unit in the active state includes a first operating mode, and a second operating mode, and, when a state of the sound emitting unit is switched from the inactive state to the active state, the operating mode of the sound emitting unit for a predetermined time after the switching is the first operating mode.

### Advantageous Effects of Invention

The present invention enables the earphone device to perform desired functions when the earphone device is worn in an ear.

### BRIEF DESCRIPTION OF DRAWINGS

FIG. 1 is a perspective view of an earphone device according to the present invention illustrating an embodiment of the earphone device.

FIG. 2 is a functional block diagram of the earphone device in FIG. 1.

FIG. 3 is a perspective view of a charger in a state in which the earphone device in FIG. 1 is accommodated.

FIG. 4 is a functional block diagram of the earphone device in a state in which the earphone device is accommodated in the charger in FIG. 3.

FIG. 5 is a functional block diagram of the earphone device in a state in which the earphone device is removed from the charger in FIG. 3.

FIG. 6 is a sequence diagram illustrating operations of the earphone device in FIG. 1.

FIG. 7 is a sequence diagram illustrating other operations of the earphone device in FIG. 1.

FIG. 8 is another functional block diagram of the earphone device in a state in which the earphone device is removed from the charger in FIG. 3.

FIG. 9 is a flowchart illustrating operations of the earphone device in FIG. 8.

### DESCRIPTION OF EMBODIMENTS

### First Embodiment

An embodiment (hereinafter referred to as a “first embodiment”) of an earphone device (hereinafter referred to as a “present device”) according to the present invention will be described below with reference to the drawings.

### Configuration of Earphone Device

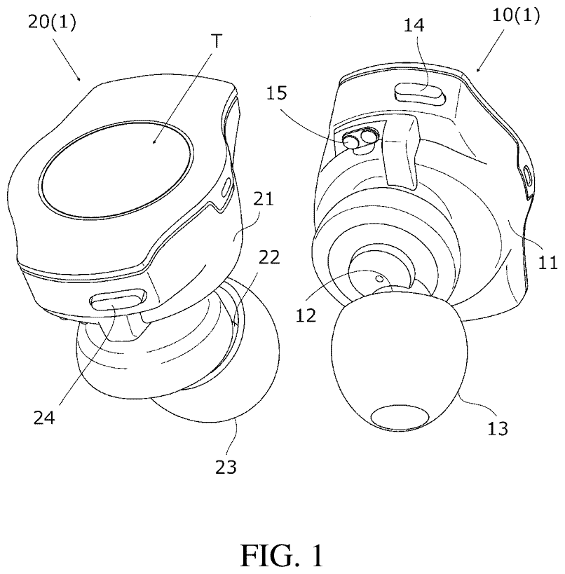

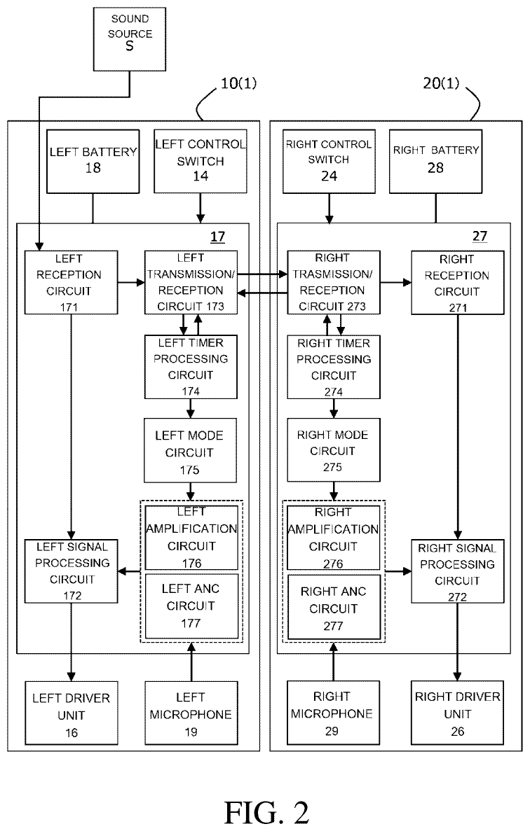

FIG. 1 is a perspective view of the present device 1 illustrating the first embodiment of the present device 1. FIG. 2 is a functional block diagram of the present device 1.

The present device 1 is worn on an ear of a user, and outputs a sound wave corresponding to an audio signal from a sound source S such as a portable terminal including a smartphone and a portable musical sound player. The present device 1 receives the audio signal from the sound source S via a wireless communication line such as Bluetooth (registered trademark), for example.

The “user” is a natural person who uses the present device 1 by wearing the present device 1 on the user's ear.

The present device 1 includes a left sound emitting unit 10 and a right sound emitting unit 20. The present device 1 is what is called a fully wireless earphone in which the left sound emitting unit 10 and the right sound emitting unit 20 are not physically connected to each other with a cable or the like.

The left sound emitting unit 10 is worn on the user's left ear, and outputs the sound wave corresponding to the audio signal from the sound source S. The left sound emitting unit 10 includes a left housing 11, a left sound conduit 12, a left earpiece 13, a left control switch 14, a left power receiving terminal 15, a left driver unit 16, a left circuit board 17, a left battery 18, and a left microphone 19. The left sound emitting unit 10 is one example of a sound emitting unit in the present invention, and is one example of a first sound emitting unit.

The left housing 11 accommodates the left driver unit 16, the left circuit board 17, the left battery 18, and the left microphone 19. The left housing 11 is made of synthetic resin such as plastic, for example.

The left sound conduit 12 guides a sound wave from the left driver unit 16 to an external auditory canal of the user's left ear during use of the present device 1. The left sound conduit 12 is integrally formed with the left housing 11.

The left earpiece 13 comes into close contact with the external auditory canal of the user in a state in which the left sound emitting unit 10 is worn on the left ear. The left earpiece 13 is attached to an outer peripheral surface of the left sound conduit 12. The left earpiece 13 is an elastic material such as silicone rubber, for example.

The left control switch 14 is a switch used for controlling an operation of the present device 1. The left control switch 14 is, for example, a pressing switch. The left control switch 14 is arranged at a portion of an outer surface of the left housing 11 exposed from the left ear in the state in which the left sound emitting unit 10 is worn on the left ear. A specific operation of the left control switch 14 will be described later. The left control switch 14 is one example of a control interface in the present invention.

Note that the left control switch in the present invention may be a touch sensor. When the left control switch is a touch sensor, a small touch sensor is arranged at a portion exposed from the left ear (for example, the outer surface of the left housing, an outermost surface [a circular region indicated by a reference sign “T” in FIG. 1] of the left housing opposite to an ear side, or the like). An operation of the touch sensor is a click, a long press, a slide, and the like by the user. The touch sensor is a known touch sensor such as a resistance film touch sensor and a capacitance touch sensor, for example.

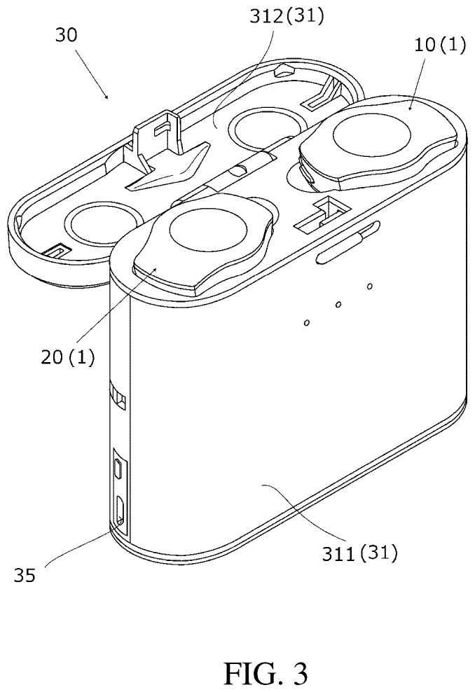

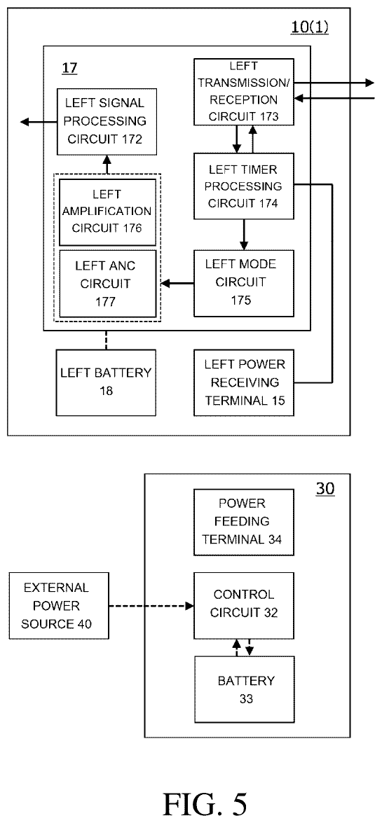

The left power receiving terminal 15 receives, from a charger 30 (see FIG. 3) described later, power to be supplied to the left battery 18. The left power receiving terminal 15 is arranged in such a manner as to be exposed to the outside of the left housing 11. As illustrated in FIG. 5, in the left housing 11, the left power receiving terminal 15 is electrically connected to the left battery 18 and a left timer processing circuit 174 described later. A specific function of the left power receiving terminal 15 will be described later.

The left driver unit 16 is driven based on the audio signal from the sound source S received from a left reception circuit 171 described later. That is, the left driver unit 16 outputs the sound wave, based on the audio signal from the sound source S. The left driver unit 16 is a dynamic electroacoustic transducer, for example. The left driver unit 16 is one example of the driver unit in the present invention.

The left circuit board 17 is a board on which an electronic circuit described later and the like are mounted. The left circuit board 17 is a printed circuit board (PCB), for example. The left circuit board 17 is electrically connected to each of the left control switch 14, the left driver unit 16, the left battery 18, and the left microphone 19.

The left reception circuit 171, a left signal processing circuit 172, a left transmission/reception circuit 173, the left timer processing circuit 174, a left mode circuit 175, a left amplification circuit 176, and a left active noise control (ANC) circuit 177 are mounted on the left circuit board 17.

The left reception circuit 171 receives the audio signal from the sound source S via the wireless communication line. The audio signal received by the left reception circuit 171 is a digital signal. The left reception circuit 171 transmits the received audio signal to the left signal processing circuit 172 and the left transmission/reception circuit 173. The left reception circuit 171 is one example of an antenna in the present invention.

The left signal processing circuit 172 processes the audio signal received from the left reception circuit 171, and transmits the processed signal to the left driver unit 16. The left signal processing circuit 172 is a D/A conversion circuit, for example. That is, the signal processed by the left signal processing circuit 172 is, for example, an analog signal subjected to D/A conversion.

The left transmission/reception circuit 173 transmits and receives a signal (the audio signal, an instruction signal described later, and the like) to and from a right transmission/reception circuit 273 of the right sound emitting unit 20 described later. A specific operation of the left transmission/reception circuit 173 will be described later. The left transmission/reception circuit 173 is one example of a first communication unit in the present invention.

The left timer processing circuit 174 includes a timer, and executes processing needed for an operation of the left sound emitting unit 10, based on a timer time. The left timer processing circuit 174 generates an instruction signal, based on the timer time, and transmits the instruction signal to the left transmission/reception circuit 173 and the left mode circuit 175. A specific operation of the left timer processing circuit 174 will be described later.

The “timer time” is a time measured by the timer included in the left timer processing circuit 174. The timer time is also measured by a timer included in a right timer processing circuit 274 described later.

The “instruction signal” is a signal generated and transmitted by the left timer processing circuit 174, and is a signal that provides, to the left mode circuit 175 and a right mode circuit 275 described later, an instruction on a timing of switching of operating modes of the left sound emitting unit 10 and the right sound emitting unit 20.

The “operating mode” is a mode indicating a state in which one function of a plurality of functions included in the left sound emitting unit 10 and the right sound emitting unit 20 is in operation. The operating mode includes a first operating mode and a second operating mode. A specific content of the operating mode will be described later.

The left mode circuit 175 switches the operating mode of the left sound emitting unit 10, based on the instruction signal from the left timer processing circuit 174. The operating mode of the left sound emitting unit 10 includes a hear-through mode and a noise canceling (ANC) mode. The left mode circuit 175 switches connection between either the left amplification circuit 176 or the left ANC circuit 177 and the left timer processing circuit 174. In the present embodiment, the operating mode of the left sound emitting unit 10 when the left sound emitting unit 10 is switched from an inactive state to an active state is the first operating mode, and the operating mode of the left sound emitting unit 10 after switching from the first operating mode is the second operating mode.

The “hear-through mode” is an operating mode in which a hear-through function is activated, allowing a user to hear surrounding sounds by taking external sounds of the left sound emitting unit 10 into the left sound emitting unit 10.

The “noise canceling mode” is an operating mode in which a noise canceling function is activated output a canceling sound with an opposite phase to the external sound of the left sound emitting unit 10 (sound around a user) from the left sound emitting unit 10, thereby silencing (canceling) the external sound.

The “inactive state” is a state in which the left sound emitting unit 10 is not in operation. The inactive state is, for example, a state in which supply of power from the left battery 18 to the electronic circuit of the left circuit board 17 is stopped and the electronic circuit mounted on the left circuit board 17 is not in operation.

The “active state” is a state in which the left sound emitting unit 10 is in operation. The active state is, for example, a state in which power from the left battery 18 is supplied to the electronic circuit of the left circuit board 17 and the electronic circuit mounted on the left circuit board 17 is in operation.

The left amplification circuit 176 amplifies the external sound of the left sound emitting unit 10 collected by the left microphone 19, and transmits the external sound to the left sound emitting unit 172 as an amplification signal. When the left sound emitting unit 10 operates in the hear-through mode, the left mode circuit 175 puts the left amplification circuit 176 in operation. The left amplification circuit 176 is a known amplification circuit, for example.

The left ANC circuit 177 generates a canceling signal with an opposite phase corresponding the external sound of the left sound emitting unit 10 collected by the left microphone 19, and transmits the canceling signal to the left signal processing circuit 172. When the left sound emitting unit 10 operates in the noise canceling mode, the left mode circuit 175 puts the left ANC circuit 177 in operation. The left ANC circuit 177 is a known ANC circuit, for example.

Note that the operating mode of the left sound emitting unit may include a “normal mode”, which activates neither the hear-through function nor the noise canceling function. That is, the operating mode of the left sound emitting unit 10 may include the “normal mode”, and one of the “hear-through mode” or the “noise canceling mode”. When the operating mode of the left sound emitting unit is the normal mode, the left mode circuit does not put both circuits of the left amplification circuit and the left ANC circuit in operation.

The left battery 18 stores power needed for an operation of the left sound emitting unit 10 (for example, power supplied to the left circuit board 17, and the like). The left battery 18 is one example of a battery in the present invention.

The left microphone 19 collects the external sound of the left sound emitting unit 10. The left microphone 19 is a known condenser microphone, for example.

The right sound emitting unit 20 is worn on a user's right ear, and outputs the sound wave corresponding to the audio signal from the sound source S. A configuration of the right sound emitting unit 20 is common to the configuration of the left sound emitting unit 10. That is, the right sound emitting unit 20 includes a right housing 21, a right sound conduit 22, a right earpiece 23, a right control switch 24, a right power receiving terminal (not illustrated), a right driver unit 26, a right circuit board 27, a right battery 28, and a right microphone 29. The right sound emitting unit 20 is one example of the second sound emitting unit in the present invention.

The right housing 21, the right sound conduit 22, the right earpiece 23, the right control switch 24, the right power receiving terminal, the right driver unit 26, the right circuit board 27, the right battery 28, and the right microphone 29 correspond to the left housing 11, the left sound conduit 12, the left earpiece 13, the left control switch 14, the left power receiving terminal 15, the left driver unit 16, the left circuit board 17, the left battery 18, and the left microphone 19, respectively. The corresponding components have the same function. The right control switch 24 is one example of the control interface in the present invention. The right driver unit 26 is one example of the driver unit in the present invention. The right battery 28 is one example of the battery in the present invention.

The right circuit board 27 is electrically connected to each of the right control switch 24, the right driver unit 26, the right battery 28, and the right microphone 29.

A right reception circuit 271, a right signal processing circuit 272, the right transmission/reception circuit 273, the right timer processing circuit 274, the right mode circuit 275, a right amplification circuit 276, and a right ANC circuit 277 are mounted on the right circuit board 27. The right reception circuit 271, the right signal processing circuit 272, the right transmission/reception circuit 273, the right timer processing circuit 274, the right mode circuit 275, the right amplification circuit 276, and the right ANC circuit 277 correspond to the left reception circuit 171, the left signal processing circuit 172, the left transmission/reception circuit 173, the left timer processing circuit 174, the left mode circuit 175, the left amplification circuit 176, and the left ANC circuit 177, respectively. The corresponding components have the same function. Thus, in the description of the right circuit board 27, the description of an operation of the right circuit board 27 that is common to the left circuit board 17 will be omitted. The right reception circuit 271 is one example of the antenna in the present invention. The right transmission/reception circuit 273 is one example of a second communication unit in the present invention.

### Configuration of Charger

Next, a configuration of the charger 30 of the present device 1 will be described. In the following description, FIGS. 1 to 2 are referred to as appropriate.

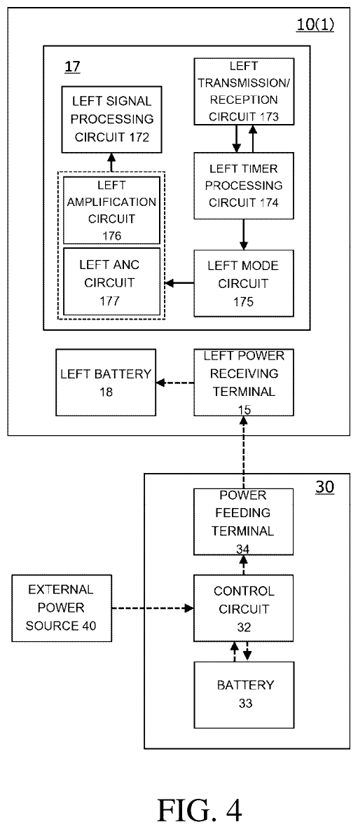

FIG. 3 is a perspective view of the charger 30 in a state in which the present device 1 is accommodated. The figure illustrates a state in which each of the left sound emitting unit 10 and the right sound emitting unit 20 is accommodated in the charger 30 and a lid portion 312 described later is open. FIG. 4 is a functional block diagram of each of the present device 1 and the charger 30. The figure illustrates a state in which the present device 1 is accommodated in the charger 30. In the figure, a dotted line indicates a flow of power and a solid line indicates a flow of a signal.

The charger 30 is a charger dedicated to the present device 1. When the left sound emitting unit 10 and the right sound emitting unit 20 are accommodated in the charger 30, each of the left sound emitting unit 10 and the right sound emitting unit 20 is electrically connected to the charger 30. When the left sound emitting unit 10 and the right sound emitting unit 20 are accommodated in the charger 30, each of the left battery 18 of the left sound emitting unit 10 and the right battery 28 of the right sound emitting unit 20 is charged. The charger 30 includes a case portion 31, a control circuit 32, a battery 33, a power feeding terminal 34, and an external power source terminal 35.

The case portion 31 includes a main body 311, a lid portion 312, and an accommodating portion (not illustrated). The case portion 31 is made of synthetic resin such as plastic, for example.

The main body 311 accommodates the accommodating portion, the control circuit 32, the battery 33, and the power feeding terminal 34. The main body 311 has a hollow tubular shape with a bottom and a rectangular shape with round corners in a plan view.

The lid portion 312 prevents each of the left sound emitting unit 10 and the right sound emitting unit 20 accommodated in the accommodating portion from coming out of the accommodating portion. The lid portion 312 is attached to the main body 311 in such a manner that allows the lid portion 312 to be opened and closed. When the lid portion 312 closes the main body 311, the lid portion 312 is locked to the main body 311.

The control circuit 32 controls an operation of the charger 30. The control circuit 32 is electrically connected to each of the battery 33, the power feeding terminal 34, and the external power source terminal 35. A specific operation of the control circuit 32 will be described later.

The battery 33 stores power from an external power source 40. The power from the external power source 40 is supplied to the battery 33 via the control circuit 32. When the left sound emitting unit 10 and the right sound emitting unit 20 are accommodated in the charger 30, the power stored in the battery 33 is supplied to each of the left sound emitting unit 10 and the right sound emitting unit 20 via the control circuit 32. Even when the charger 30 is not connected to the external power source 40, the power stored in the battery 33 is supplied to each of the accommodated left sound emitting unit 10 and right sound emitting unit 20.

The power feeding terminal 34 is arranged in such a manner as to be exposed to the inside of the accommodating portion. The power feeding terminal 34 is electrically connected to the control circuit 32, and is connected to the battery 33 via the control circuit 32.

When the left sound emitting unit 10 is accommodated in the charger 30, the left power receiving terminal 15 is electrically connected to the power feeding terminal 34. In this state, supply of power to the left battery 18 of the left sound emitting unit 10 is performed. In contrast, when the left sound emitting unit 10 is removed from the charger 30, electrical connection between the left power receiving terminal 15 and the power feeding terminal 34 is disconnected. In this state, supply of power to the left battery 18 of the left sound emitting unit 10 is stopped. In the right sound emitting unit 20, a relationship between the power feeding terminal 34 and the right power receiving terminal (not illustrated) is common to the relationship between the power feeding terminal 34 and the left power receiving terminal 15.

The external power source terminal 35 is, for example, a universal serial bus (USB) terminal for a USB cable that supplies the power from the external power source 40 to the battery 33. The external power source terminal 35 is arranged on an outer surface of the main body 311.

### Relationship Between Earphone Device and Charger

Next, a relationship between the present device 1 and the charger 30 will be described. In the following description, the relationship between the present device 1 and the charger 30 will be described with the left sound emitting unit 10 as an example.

First, an operation of the left sound emitting unit 10 and the charger 30 in a state in which the left sound emitting unit 10 is accommodated in the charger 30 will be described (see FIG. 4). When the charger 30 is connected to the external power source 40, the control circuit 32 monitors and controls a flow of power. The control circuit 32 monitors a storage state of the battery 33, and supplies power to the battery 33 when the battery 33 is not fully charged, or stops supplying power to the battery 33 when the battery 33 is fully charged. In this way, the control circuit 32 appropriately monitors the storage state of the battery 33, and controls the storage state of the battery 33.

When the left sound emitting unit 10 is accommodated in the charger 30, the control circuit 32 detects that the left power receiving terminal 15 and the power feeding terminal 34 are electrically connected. The control circuit 32 that has detected the connection supplies power to the left battery 18 via the power feeding terminal 34 and the left power receiving terminal 15. As a result, the left battery 18 stores the supplied power. That is, when the left sound emitting unit 10 is accommodated in the charger 30, the left battery 18 is charged. When the left sound emitting unit 10 is accommodated in the charger 30, a state of the left sound emitting unit 10 is the inactive state.

Next, an operation of the left sound emitting unit 10 and the charger 30 in a state in which the left sound emitting unit 10 is removed from the charger 30 will be described.

FIG. 5 is a functional block diagram of each of the present device 1 and the charger 30. The figure illustrates a state in which the present device 1 is removed from the charger 30.

When the left sound emitting unit 10 is removed from the charger 30, electrical connection between the left power receiving terminal 15 and the power feeding terminal 34 is disconnected. In this state, the control circuit 32 of the charger 30 detects that the electrical connection between the left power receiving terminal 15 and the power feeding terminal 34 is disconnected. The control circuit 32 that has detected the disconnection of the electrical connection stops supply of power from the battery 33 to the power feeding terminal 34.

When the left sound emitting unit 10 is removed from the charger 30, the left timer processing circuit 174 of the left sound emitting unit 10 detects that the electrical connection between the left power receiving terminal 15 and the power feeding terminal 34 is disconnected. The left timer processing circuit 174 that has detected the disconnection of the electrical connection generates an instruction signal to instruct the switching to the first operating mode and transmits the instruction signal to the left mode circuit 175 and the left transmission/reception circuit 173.

When the left sound emitting unit 10 is removed from the charger 30, the connection between the left power receiving terminal 15 and the power feeding terminal 34 is disconnected, and thus supply of power to the left battery 18 is stopped. In this state, supply of power from the left battery 18 to the electronic circuit of the left circuit board 17 starts. In other words, when the left sound emitting unit 10 is removed from the charger 30, a state of the left sound emitting unit 10 is switched from the inactive state to the active state. That is, when the left sound emitting unit 10 is not accommodated in the charger 30, a state of the left sound emitting unit 10 is the active state.

The relationship between the left sound emitting unit 10 and the charger 30 described above is common to a relationship between the right sound emitting unit 20 and the charger 30.

### Operation (1) of Earphone Device

Next, an operation of the present device 1 will be described.

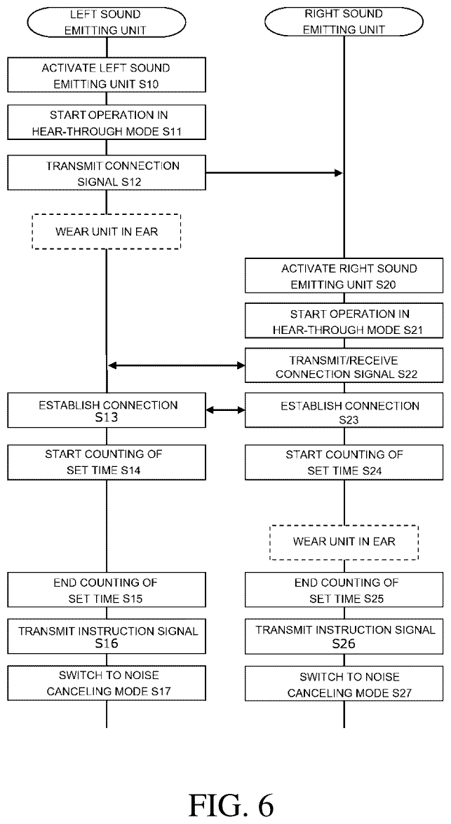

FIG. 6 is a sequence diagram illustrating an operation of the present device 1. The figure is a sequence diagram illustrating one example in which operating modes of the left sound emitting unit 10 and the right sound emitting unit 20 are switched from the hear-through mode to the noise canceling mode.

In the following description of the operations of the present device 1, it is assumed that, among the left sound emitting unit 10 and the right sound emitting unit 20, a user removes the left sound emitting unit 10 from the charger 30 and wears the left sound emitting unit 10 in the user's ear, and then removes the right sound emitting unit 20 from the charger 30 and wears the right sound emitting unit 20 in the user's another ear.

When the left sound emitting unit 10 is removed from the charger 30 by the user, power from the left battery 18 is supplied to the electronic circuit mounted on the left circuit board 17, and the left sound emitting unit 10 is activated (S10). In other words, when the left sound emitting unit 10 is removed from the charger 30, a state of the left sound emitting unit 10 is switched from the inactive state to the active state.

Further, when the left sound emitting unit 10 is removed from the charger 30, the left sound emitting unit 10 starts operating in the hear-through mode being the first operating mode (S11). That is, when the state of the left sound emitting unit 10 is switched from the inactive state to the active state, an operating mode of the left sound emitting unit 10 is the hear-through mode being the first operating mode.

Then, the left sound emitting unit 10 transmits a connection signal from the left transmission/reception circuit 173 (S12).

The “connection signal” is a signal transmitted and received between the left transmission/reception circuit 173 and the right transmission/reception circuit 273 in order to establish communication connection between the left sound emitting unit 10 and the right sound emitting unit 20.

When the state of the left sound emitting unit 10 is switched from the inactive state to the active state and an audio signal from the sound source S is received by the left reception circuit 171, the audio signal is transmitted to the left signal processing circuit 172 and the left transmission/reception circuit 173. Further, the left ANC circuit 177 generates a canceling signal and transmits the canceling signal to the left signal processing circuit 172. In the left signal processing circuit 172, the audio signal transmitted from the left reception circuit 171 and the canceling signal transmitted from the left ANC circuit 177 are superimposed and transmitted to the left driver unit 16. The left driver unit 16 outputs a sound wave for putting the noise canceling function in operation, based on the superimposed signal.

The left sound emitting unit 10 removed from the charger 30 is worn in the user's left ear in a state in which the hear-through mode being the first operating mode is in operation. Since the left sound emitting unit 10 worn in the left ear is in operation in the hear-through mode, the user can hear external sounds heard from the left ear in which the left sound emitting unit 10 is worn in the same manner as hearing external sounds heard from the right ear without anything worn. Accordingly, the user can hear the external sounds from both of the ears without feeling a sense of discomfort.

Then, the right sound emitting unit 20 is removed from the charger 30 by the user. When the right sound emitting unit 20 is removed from the charger 30, power from the right battery 28 is supplied to the electronic circuit mounted on the right circuit board 27, and the right sound emitting unit 20 is activated (S20). In other words, when the right sound emitting unit 20 is removed from the charger 30, a state of the right sound emitting unit 20 is switched from the inactive state to the active state.

Further, when the right sound emitting unit 20 is removed from the charger 30, the right sound emitting unit 20 starts operating in the hear-through mode being the first operating mode (S21). That is, when the state of the right sound emitting unit 20 is switched from the inactive state to the active state, the operating mode of the right sound emitting unit 20 is the hear-through mode being the first operating mode.

When the state of the right sound emitting unit 20 is switched from the inactive state to the active state and an audio signal from the sound source S is received by the left reception circuit 171, the audio signal is transmitted to the right signal processing circuit 272 via the left transmission/reception circuit 173 and the right transmission/reception circuit 273. Further, the right ANC circuit 277 generates a canceling signal and transmits the canceling signal to the right signal processing circuit 272. In the right signal processing circuit 272, the audio signal transmitted from the right transmission/reception circuit 273 and the canceling signal transmitted from the right ANC circuit 277 are superimposed and transmitted to the right driver unit 26. The right driver unit 26 outputs a sound wave for putting the noise canceling function in operation, based on the superimposed signal.

Then, in the right sound emitting unit 20, the connection signal transmitted from the left transmission/reception circuit 173 is received by the right transmission/reception circuit 273. The received connection signal is transmitted from the right transmission/reception circuit 273 to the left transmission/reception circuit 173 (S22).

Then, in the left sound emitting unit 10 and the right sound emitting unit 20, when the connection signal is transmitted and received between the left transmission/reception circuit 173 and the right transmission/reception circuit 273, connection is established (S13, S23). In other words, the connection is established at the moment at which the left transmission/reception circuit 173 is notified by the right transmission/reception circuit 273 that the right sound emitting unit 20 is in the active state.

When the connection is established, the left timer processing circuit 174 starts counting a set time that has been set in advance (S14). Similarly, when the connection is established, the right timer processing circuit 20 starts counting the set time that has been set in advance (S24).

The “set time” is a time being set as an assumed elapsed time, with one sound emitting unit (the left sound emitting unit 10 in the present embodiment) already removed from the charger 30, from when the other sound emitting unit (the right sound emitting unit 20 in the present embodiment) is removed from the charger 30 until the wearing of the other sound emitting unit (right sound emitting unit 20) is completed. In the present embodiment, a time at which the connection is established is regarded as a timing for removing the other sound emitting unit (right sound emitting unit 20). When counting of the set time ends, it is assumed that the left sound emitting unit 10 and the right sound emitting unit 20 are worn in the ears in the present device 1, and an operation described later (switching of the operating mode) is performed. In the present embodiment, the set time is set in advance. In the present embodiment, the set time is, for example, two seconds.

Note that, in the present invention, the set time may be set based on a comparison result of timer times measured by the left and right timer processing circuits as described later in a second embodiment.

Herein, the present device 1 does not include a wearing sensor included in a conventional fully wireless earphone. Thus, in the present device 1, the moment at which the connection is established is set as a timing for removing the other sound emitting unit (right sound emitting unit 20), and the time when the set time has elapsed from the above timing is set as a timing of wearing the left sound emitting unit 10 and the right sound emitting unit 20. These settings cause the left sound emitting unit 10 and the right sound emitting unit 20 to operate in the hear-through mode before being worn in both of the user's ears and to automatically operate in the noise canceling mode at the timing when the left sound emitting unit 10 and the right sound emitting unit 20 are worn in both of the user's ears. That is, the operating modes of the left sound emitting unit 10 and the right sound emitting unit 20 are automatically switched from the first operating mode (hear-through mode) to the second operating mode (noise canceling mode) at the timing when the left sound emitting unit 10 and the right sound emitting unit 20 are worn in both of the user's ears. Accordingly, the user can hear external sounds without feeling a sense of discomfort and stress in a state in which the one sound emitting unit (left sound emitting unit 10) is worn in one ear, and can hear a musical sound with the external sounds removed at the timing when the left sound emitting unit 10 and the right sound emitting unit 20 are worn in both of the user's ears. In this way, in the present device 1, the switching from the hear-through mode to the noise canceling mode can be performed without the user feeling a sense of discomfort and stress.

When counting of the set time ends (S15, S25), the left timer processing circuit 174 transmits an instruction signal to the left mode circuit 175 (S16). Similarly, the right timer processing circuit 274 transmits an instruction signal to the right mode circuit 275 (S26).

The left mode circuit 175 that has received the instruction signal switches the electronic circuit connected to the left signal processing circuit 172 from the left amplification circuit 176 to the left ANC circuit 177. Similarly, the right mode circuit 275 that has received the instruction signal switches the electronic circuit connected to the right signal processing circuit 272 from the right amplification circuit 276 to the right ANC circuit 277. That is, the operating modes of the left sound emitting unit 10 and the right sound emitting unit 20 are simultaneously switched from the hear-through mode to the noise canceling mode (S17, S27). In other words, after the state of the left sound emitting unit 10 is switched from the inactive state to the active state (after the switching) and then a standby time has elapsed, the operating modes of the left sound emitting unit 10 and the right sound emitting unit 20 are switched from the first operating mode (hear-through mode) to the second operating mode (noise canceling mode).

The “standby time” is a duration for which the left sound emitting unit 10 (right sound emitting unit 20), having entered the active state, stands by in the first operating mode without switching the operating mode. In other words, the standby time is a duration from a time at which the left sound emitting unit 10 (right sound emitting unit 20) starts operating in the first operating mode to a time at which the operating mode of the left sound emitting unit 10 (right sound emitting unit 20) is switched to the second operating mode. In the present embodiment, the standby time is set, assuming the time from the time when one sound emitting unit (left sound emitting unit 10) is removed from the charger 30 to the time when the other sound emitting unit (right sound emitting unit 20) is worn in the ear. In the present embodiment, the standby time is a total duration, consisting of the duration from the time (the moment) when the state of the left sound emitting unit 10 is switched from the inactive state to the active state to the time when the connection is established (in other words, the moment at which the state of the right sound emitting unit 20 is switched from the inactive state to the active state) and the duration from the time when counting of the set time starts to the time when the counting ends. The standby time is one example of a predetermined time in the present invention.

While the set time is counted, the right sound emitting unit 20 is worn in the right ear in a state of in which the right sound emitting unit 20 operates in the hear-through mode being the first operating mode. Herein, the operating modes of the left sound emitting unit 10 and the right sound emitting unit 20 are the hear-through mode until the set time elapses. Thus, the user can hear external sounds from both of the ears even when the left sound emitting unit 10 and the right sound emitting unit 20 are worn in both of the ears. After the left sound emitting unit 10 and the right sound emitting unit 20 are worn in both of the ears, the operating modes of the left sound emitting unit 10 and the right sound emitting unit 20 are switched from the hear-through mode to the noise canceling mode. Thus, the user can actually feel that the hear-through mode is switched to the noise canceling mode.

In the left sound emitting unit 10, the left ANC circuit 177 transmits the canceling signal to the left signal processing circuit 172. In the left signal processing circuit 172, the audio signal transmitted from the left reception circuit 171 and the canceling signal transmitted from the left ANC circuit 177 are superimposed and transmitted to the left driver unit 16. A sound wave for putting the noise canceling function in operation is output from the left driver unit 16, based on the superimposed signal. Also, in the right sound emitting unit 20, an operation similar to that in the left sound emitting unit 10 is performed, and a sound wave for putting the noise canceling function in operation is output.

### Conclusion (1)

According to the embodiment described above, the present device 1 includes the left sound emitting unit 10 (right sound emitting unit 20) to be worn in the ear of a user. The left sound emitting unit 10 (right sound emitting unit 20) includes the left reception circuit 171 (right reception circuit 271), the left driver unit 16 (right driver unit 26), and the left battery 18 (right battery 28). The left sound emitting unit 10 (right sound emitting unit 20) is in the inactive state when the left sound emitting unit 10 (right sound emitting unit 20) is accommodated in the charger 30, and is in the active state when the left sound emitting unit 10 (right sound emitting unit 20) is not accommodated in the charger 30. The operating mode of the left sound emitting unit 10 (right sound emitting unit 20) in such an active state includes the first operating mode and the second operating mode. When the state of the left sound emitting unit 10 (right sound emitting unit 20) is switched from the inactive state to the active state, the operating mode of the left sound emitting unit 10 (right sound emitting unit 20) for a first standby time (predetermined time) after the switching is the first operating mode. According to this configuration, when the state of the left sound emitting unit 10 (right sound emitting unit 20) is switched from the inactive state to the active state, the left sound emitting unit 10 (right sound emitting unit 20) operates in the first operating mode after the switching and until the standby time elapses. Thus, when the user wears the left sound emitting unit 10 (right sound emitting unit 20) in the ear, the left sound emitting unit 10 (right sound emitting unit 20) already operates in the first operating mode, and thus a desired function (hear-through function in the present embodiment) is put in operation without making the user feel stressed.

According to the embodiment described above, in the present device 1, when the state of the left sound emitting unit 10 (right sound emitting unit 20) is switched from the inactive state to the active state and after the first standby time (predetermined time) has elapsed after the above switching, the operating mode of the left sound emitting unit 10 (right sound emitting unit 20) is the second operating mode. According to this configuration, after the state is switched and then the standby time has elapsed, the operating mode of the left sound emitting unit 10 (right sound emitting unit 20) is automatically switched to the second operating mode. Thus, when the user wears the left sound emitting unit 10 (right sound emitting unit 20) in the ear, the operating mode is switched without making the user feel stressed and a desired function is put in operation in the left sound emitting unit 10 (right sound emitting unit 20).

According to the embodiment described above, the present device 1 includes the left sound emitting unit 10 and the right sound emitting unit 20. When the left sound emitting unit 10 is switched to the active state while the left sound emitting unit 10 and the right sound emitting unit 20 are in the inactive state, the operating mode of the left sound emitting unit 10 is the first operating mode until the right sound emitting unit 20 is switched to the active state. According to this configuration, when the left sound emitting unit 10 is switched to the active state, the operating mode of the left sound emitting unit 10 is already in operation in the first operating mode. Thus, when the user wears the left sound emitting unit 10 in the ear, the left sound emitting unit 10 is already in operation in the first operating mode, and thus a desired function is put in operation without making the user feel stressed.

According to the embodiment described above, after the right sound emitting unit 20 is switched to the active state and then the standby time (predetermined time) has elapsed, the operating mode of the left sound emitting unit 10 operating in the first operating mode is switched to the second operating mode. According to this configuration, after the right sound emitting unit 20 is switched to the active state and then the standby time has elapsed, the operating mode of the left sound emitting unit 10 is automatically switched to the second operating mode. Thus, no accidental operation occurs in switching the operating mode, thereby switching the operating mode without making the user feel stressed and putting a desired function in operation.

According to the embodiment described above, the left sound emitting unit 10 (right sound emitting unit 20) has the noise canceling function, in which the noise canceling function is disabled in the first operating mode, and the noise canceling function is enabled in the second operating mode. According to the configuration, the left sound emitting unit 10 (right sound emitting unit 20) automatically switches the noise canceling function between enabled and disabled states, and thus there is no accidental operation by the user in the left sound emitting unit 10 (right sound emitting unit 20), and the user does not feel stressed. By setting the set time (standby time) in such a manner that the noise canceling function is switched to be enabled in the left sound emitting unit 10 (right sound emitting unit 20) after the left sound emitting unit 10 (right sound emitting unit 20) is worn on the ear of the user, the user can actually feel that the function is switched to the noise canceling function.

According to the embodiment described above, the left sound emitting unit 10 (right sound emitting unit 20) has the hear-through function, in which the hear-through function is enabled in the first operating mode, and the hear-through function is disabled in the second operating mode. According to the configuration, the left sound emitting unit 10 (right sound emitting unit 20) is worn in one ear of the user in a state of in which the hear-through function is in operation. Thus, the user can hear external sounds in the same way as with the ear where the left sound emitting unit 10 is worn and the ear without anything worn. In other words, the user can hear external sounds from both of the ears without feeling a sense of discomfort.

According to the embodiment described above, the left sound emitting unit 10 includes the left transmission/reception circuit 173, and the right sound emitting unit 20 includes the right transmission/reception circuit 273. The standby time (predetermined time) is determined based on the moment at which the left transmission/reception circuit 173 is notified by the right transmission/reception circuit 273 that the right sound emitting unit 20 is in the active state. According to the configuration, even when the left sound emitting unit 10 and the right sound emitting unit 20 do not include a wearing sensor, the user estimates a timing for wearing the left sound emitting unit 10 and the right sound emitting unit 20, and thus the operating modes of the left sound emitting unit 10 and the right sound emitting unit 20 are switched at an appropriate timing. Further, when only one of the sound emitting units is used, the first operating mode is maintained. That is, while only one of the sound emitting units is worn in one ear, an appropriate operating mode to be used in one ear is maintained.

According to the embodiment described above, in the present device 1, the operating mode of the right sound emitting unit 20 switched from the inactive state to the active state is switched from the first operating mode to the second operating mode when the left sound emitting unit 10 is switched from the first operating mode to the second operating mode. According to the configuration, the operating modes of the left sound emitting unit 10 and the right sound emitting unit 20 worn in the left and right ears can be simultaneously switched.

Note that, in the present invention, the first operating mode may be the noise canceling mode and the second operating mode may be the hear-through mode.

In the present invention, the operating mode may be switched when the connection between the left transmission/reception circuit and the right transmission/reception circuit is closed. For example, there is a case where the user who is using the left and right sound emitting units removes one of the sound emitting units from one ear and accommodates the sound emitting unit in the charger. In such a case, the operating mode of the other sound emitting unit is controlled in such a manner that the connection between the left transmission/reception circuit and the right transmission/reception circuit being closed triggers the operating mode to switch from the noise canceling mode to the hear-through mode.

### Second Embodiment

Next, another embodiment (hereinafter referred to as a “second embodiment”) of the present device 1 will be described with a focus on differences from the first embodiment described above. The second embodiment differs from the first embodiment in that the set time is set based on a result of comparing time from the time when the states of the left sound emitting unit 10 and the right sound emitting unit 20 are switched from the inactive state to the active state to the time when the connection is established, among the operations of the present device 1. In the following description, components in common with the first embodiment are indicated with the same reference signs, and description thereof will be partially or completely omitted.

### Operation (2) of Earphone Device

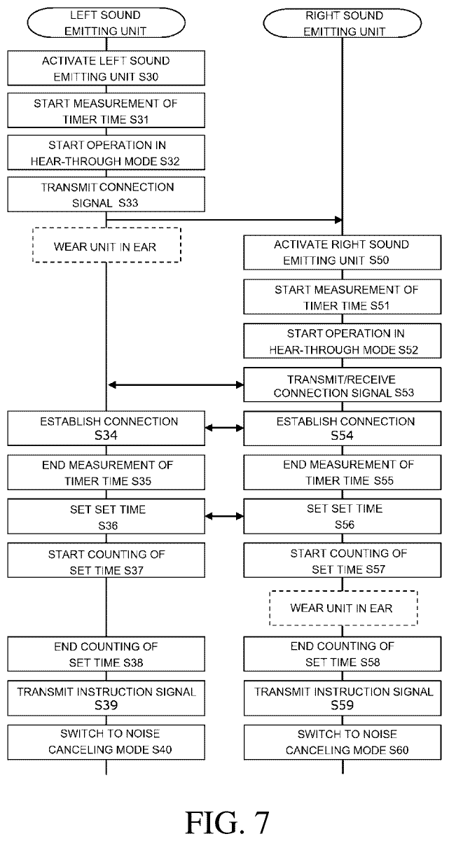

FIG. 7 is a sequence diagram illustrating another operation of the present device 1. The figure is a sequence diagram illustrating one example in which the operating modes of the left sound emitting unit 10 and the right sound emitting unit 20 are switched from the hear-through mode to the noise canceling mode.

When the left sound emitting unit 10 is removed from the charger 30 by a user, power from the left battery 18 is supplied to the electronic circuit mounted on the left circuit board 17, and the left sound emitting unit 10 is activated (S30).

Then, the left sound emitting unit 10 starts measurement of a timer time by the left timer processing circuit 174 (S31).

Further, the left sound emitting unit 10 starts operating in the hear-through mode being the first operating mode (S32).

Then, the left sound emitting unit 10 transmits a connection signal from the left transmission/reception circuit 173 (S33).

The left sound emitting unit 10 removed from the charger 30 is worn in the user's left ear in a state of in which the hear-through mode being the first operating mode is in operation. Since the left sound emitting unit 10 worn in the left ear is in operation in the hear-through mode, the user can hear external sounds heard from the left ear in which the left sound emitting unit 10 is worn in the same manner as hearing external sounds heard from the right ear without anything worn. Accordingly, the user can hear the external sounds from both of the ears without feeling a sense of discomfort.

Then, the right sound emitting unit 20 is removed from the charger 30 by the user. When the right sound emitting unit 20 is removed from the charger 30, power from the right battery 28 is supplied to the electronic circuit mounted on the right circuit board 27, and the right sound emitting unit 20 is activated (S50).

Then, the right sound emitting unit 20 starts measurement of the timer time by the right timer processing circuit 274 (S51).

Further, the right sound emitting unit 20 starts operating in the hear-through mode being the first operating mode (S52).

Then, the connection signal transmitted from the left transmission/reception circuit 173 is received by the right transmission/reception circuit 273. The received connection signal is transmitted from the right transmission/reception circuit 273 to the left transmission/reception circuit 173 (S53).

Then, in the left sound emitting unit 10 and the right sound emitting unit 20, when the connection signal is transmitted and received between the left transmission/reception circuit 173 and the right transmission/reception circuit 273, the connection is established (S34, S54).

The left timer processing circuit 174 ends measurement of the timer time by the left timer processing circuit 174 when the connection is established (S35). Similarly, the right sound emitting unit 20 ends measurement of the timer time by the right timer processing circuit 274 (S55).

The left timer processing circuit 174 compares a measurement result (time A) of the timer time of the left timer processing circuit 174 with a measurement result (time B) of the timer time of the right timer processing circuit 274, and sets the set time (S36, S56). The left timer processing circuit 174 executes the following processing. First, the left timer processing circuit 174 compares the time A with the time B. Then, the left timer processing circuit 174 selects a longer timer time (time A, time B) as a result of comparing the time A with the time B. The selected timer time is a first candidate time being a candidate for the set time. Herein, the left timer processing circuit 174 compares the first candidate time with a predetermined sample time (five seconds in the present embodiment). When the first candidate time is smaller than the sample time, the left timer processing circuit 174 sets the first candidate time as the set time. In contrast, when the first candidate time is equal to or more than the sample time, the left timer processing circuit 174 sets a preset second candidate time (two seconds in the present embodiment) as the set time.

Herein, as described above, the set time is set based on the comparison result of timer times measured by the left timer processing circuit 174 and the right timer processing circuit 274. The timer time of the left timer processing circuit 174 is an elapsed time (time A) from the moment at which the state of the left sound emitting unit 10 is switched from the inactive state to the active state to the moment at which the state of the right sound emitting unit 20 is switched from the inactive state to the active state (in the present embodiment, establishment of the connection is regarded as a timing at which the left sound emitting unit 10 is worn in the left ear). In contrast, the timer time of the right timer processing circuit 274 is an elapsed time (time B) from the moment at which the state of the right sound emitting unit 20 is switched from the inactive state to the active state to the moment at which the connection is established, and is an extremely short time. Thus, the present device 1 is capable of setting the set time at all times, based on the timer time (first candidate time) of the sound emitting unit (left sound emitting unit 10), which is first removed from the charger 30, by comparing the time A with the time B.

The elapsed time (time from a time at which the left sound emitting unit 10 is removed from the charger 30 to a time at which the left sound emitting unit 10 is worn in the left ear) is a unique time different for each user, but, in the present embodiment, the set time is set based on the elapsed time. Thus, in the present device 1, the desired functions can be performed at an optimum timing for each user. When the first candidate time is greater than the sample time, it is regarded in the present device 1 that only the sound emitting unit (left sound emitting unit 10), which is first removed from the charger 30, has been used by the user, and the first candidate time is not adopted as the set time of the sound emitting unit (right sound emitting unit 20) being subsequently removed from the charger 30 and the second candidate time is adopted. Thus, in both of a case where only one of the sound emitting units (left sound emitting unit 10) is used and a case where the other sound emitting unit (right sound emitting unit 20) is subsequently used, the present device 1 enables the desired functions to be performed at an appropriate timing for each of the left sound emitting unit 10 and the right sound emitting unit 20.

Then, after the set time is set by the left timer processing circuit 174, the left timer processing circuit 174 and the right timer processing circuit 274 share the set time via the left transmission/reception circuit 173 and the right transmission/reception circuit 273. The left timer processing circuit 174 and the right timer processing circuit 274 simultaneously start counting the set time, based on the set time (S37, S57).

When counting of the set time ends (S38, S58), the left timer processing circuit 174 transmits an instruction signal to the left mode circuit 175 (S39). Similarly, the right timer processing circuit 274 transmits an instruction signal to the right mode circuit 275 (S59).

Then, the operating modes of the left sound emitting unit 10 and the right sound emitting unit 20 are simultaneously switched from the hear-through mode to the noise canceling mode (S40, S50). In other words, after the state of the left sound emitting unit 10 is switched from the inactive state to the active state (after the switching) and then the standby time has elapsed, the operating modes of the left sound emitting unit 10 and the right sound emitting unit 20 are switched from the first operating mode (hear-through mode) to the second operating mode (noise canceling mode).

### Conclusion (2)

According to the embodiment described above, in the present device 1, the standby time (predetermined time) is determined based on the elapsed time from the moment at which the state of the left sound emitting unit 10 is switched from the inactive state to the active state to the moment at which the state of the right sound emitting unit 20 is switched from the inactive state to the active state. According to this configuration, a timing of switching the operating modes in the left sound emitting unit 10 and the right sound emitting unit 20 is determined based on a use condition of the user such as an elapsed time taken by the user for wearing the left sound emitting unit 10 and an elapsed time until the right sound emitting unit 20 is subsequently removed from the charger 30. Thus, switching the operating modes of the left sound emitting unit 10 and the right sound emitting unit 20 is performed at an appropriate timing depending on the user. Since switching the operating mode is performed at an appropriate timing, the desired functions are performed without making the user feel stressed.

Note that, in the present invention, the timing at which measurement of the timer time ends is not limited to the moment at which connection is established. That is, for example, the timing at which measurement of the timer time ends may be the moment at which the left sound emitting unit can transmit and receive a connection signal to and from the right sound emitting unit.

Further, in the present invention, the set time need not be set based on a result of comparing the time A with the time B. That is, for example, the set time may be determined based on the elapsed time from the moment at which the state of the left sound emitting unit is switched from the inactive state to the active state to the moment at which the state of the right sound emitting unit is switched from the inactive state to the active state. The set time may be flexibly set according to a time taken by the user for wearing the sound emitting unit, and the like.

### Third Embodiment

Next, still another embodiment (hereinafter referred to as a “third embodiment”) of the present device 1 will be described with a focus on differences from the first embodiment described above. The third embodiment differs from the first embodiment in that the first operating mode is an operation disabled mode and the second operating mode is an operation enabled mode. Further, the third embodiment differs from the first embodiment in that the time from the moment at which the state of one of the sound emitting units 10 and 20 is switched from the inactive state to the active state to the moment at which the operating mode is switched is different from that of the first embodiment, among the operations of the present device 1. In the following description, components in common with the first embodiment are indicated with the same reference signs, and description thereof will be partially or completely omitted.

### Configuration of Earphone Device and Charger

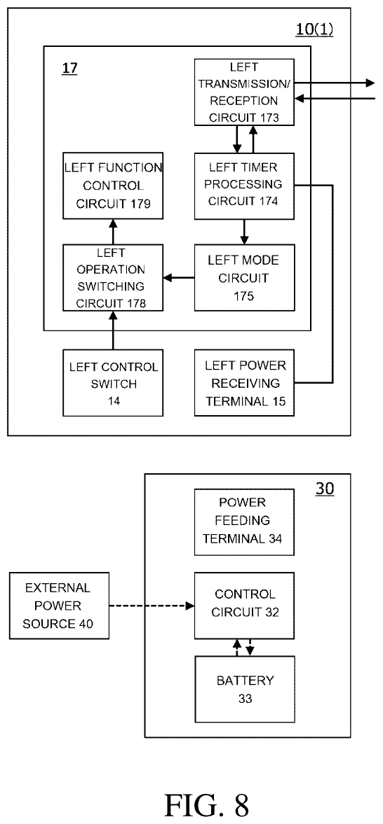

FIG. 8 is a functional block diagram of each of the present device 1 and the charger 30. The figure illustrates a state in which the present device 1 is removed from the charger 30. The figure does not illustrate each of the left signal processing circuit 172, the left amplification circuit 176, and the left ANC circuit 177 (see FIG. 5) for convenience of description.

The left signal processing circuit 172 (see FIG. 5), the left transmission/reception circuit 173, the left timer processing circuit 174, the left mode circuit 175, the left amplification circuit 176 (see FIG. 5), the left ANC circuit 177 (see FIG. 5), a left operation switching circuit 178, and a left function control circuit 179 are mounted on the left circuit board 17.

The left mode circuit 175 switches the operating mode of the left sound emitting unit 10, based on the instruction signal from the left timer processing circuit 174. The operating mode of the left sound emitting unit 10 includes an operation disabled mode and an operation enabled mode. In the present embodiment, the first operating mode is the operation disabled mode and the second operating mode is the operation enabled mode.

The “operation disabled mode” is an operating mode in which an operation signal from the left control switch 14 is not input to the left function control circuit 179 even when the left control switch 14 is operated by a user. In the operation disabled mode, the operation signal indicating an operation content of the left control switch 14 is stopped by the left operation switching circuit 178 and is not transmitted to the left function control circuit 179. Accordingly, in the left sound emitting unit 10 operating in the operation disabled mode, a function according to the operation content of the left control switch 14 is not put in operation. That is, in the left sound emitting unit 10 operating in the operation disabled mode, an operating function of the left control switch 14 is disabled.

The “operation signal” is a signal indicating the operation content of the left control switch 14 and is generated by the left control switch 14 according to the operation content of the left control switch 14 by the user. The generated operation signal is transmitted to the left function control circuit 179 via the left operation switching circuit 178.

The “operation enabled mode” is an operating mode in which the operation signal from the left control switch 14 is input to the left function control circuit 179 when the left control switch 14 is operated by the user. In the operation enabled mode, the operation signal is transmitted from the left operation switching circuit 178 to the left function control circuit 179. Accordingly, in the left sound emitting unit 10 operating in the operation enabled mode, a function according to the operation content of the left control switch 14 is put in operation. That is, in the left sound emitting unit 10 operating in the operation enabled mode, the operating function of the left control switch 14 is enabled.

The left operation switching circuit 178 is a switch circuit that controls the presence or absence of an electrical connection between the left control switch 14 and the left function control circuit 179. The left operation switching circuit 178 electrically connects the left control switch 14 to the left function control circuit 179 and disconnects the connection, based on an instruction signal from the left mode circuit 175. Specifically, when the operating mode of the sound emitting unit 10 is the first operating mode (operation disabled mode), the left operation switching circuit 178 disconnects the electrical connection between the left control switch 14 and the left function control circuit 179. In contrast, when the operating mode of the sound emitting unit 10 is the second operating mode (operation enabled mode), the left operation switching circuit 178 electrically connects the left control switch 14 to the left function control circuit 179.

The left function control circuit 179 controls an operation of each function of the left sound emitting unit 10, based on the operation signal. The functions controlled by the left function control circuit 179 include, for example, an adjustment to volume, selection of sound quality, enabling/disabling of the hear-through function and the noise canceling function, switching of a musical sound or a call sound, and the like. Specific control of the left function control circuit 179 will be described later.

### Operation (3) of Earphone Device

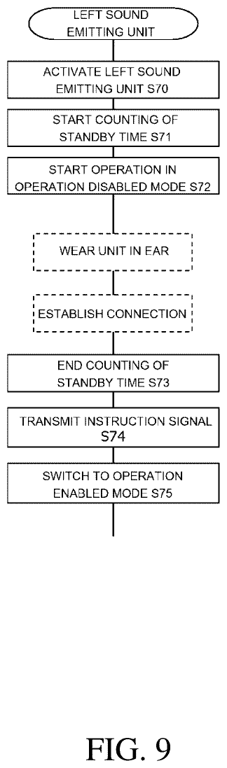

FIG. 9 is a flowchart illustrating still another operation of the present device 1. The figure illustrates one example in which the operating mode of the left sound emitting unit 10 is switched from the operation disabled mode to the operation enabled mode.

In the following description of the operations of the present device 1, it is assumed that the user first removes the left sound emitting unit 10 from the charger 30.

When the left sound emitting unit 10 is removed from the charger 30 by the user, power from the left battery 18 is supplied to the electronic circuit mounted on the left circuit board 17, and the left sound emitting unit 10 is activated (S70). At this time, a state of the left sound emitting unit 10 is switched from the inactive state to the active state.

Then, in the left sound emitting unit 10, when the left sound emitting unit 10 is removed from the charger 30, counting a preset standby time (five seconds in the present embodiment) starts (S71). At this time, the left timer processing circuit 174 starts counting the standby time.

In the present embodiment, the “standby time” is a time in which the left sound emitting unit 10 entering the active state stands by in a state of the first operating mode without switching the operating mode.

Further, when the left sound emitting unit 10 is removed from the charger 30, the left sound emitting unit 10 starts an operation in the operation disabled mode being the first operating mode (S72). That is, when a state of the left sound emitting unit 10 is switched from the inactive state to the active state, the operating mode of the left sound emitting unit 10 is the operation disabled mode being the first operating mode.

Then, the left sound emitting unit 10 transmits a connection signal from the left transmission/reception circuit 173. When the right sound emitting unit 20 is removed from the charger 30 during counting of the standby time, establishment of connection between the left sound emitting unit 10 and the right sound emitting unit 20 and the like are performed.

When counting of the standby time ends (S73), the left timer processing circuit 174 transmits the instruction signal to the left mode circuit 175 (S74).

The left mode circuit 175 that has received the instruction signal switches the operating mode of the left operation switching circuit 178 from the operation disabled mode (first operating mode) to the operation enabled mode (second operating mode) (S75). At this time, the operation of the left control switch 14 is enabled. In the left sound emitting unit 10 operating in the operation enabled mode, the operation signal by the operation of the left control switch 14 is transmitted to the left function control circuit 179. The left function control circuit 179 controls a function of the left sound emitting unit 10, based on the operation signal. That is, for example, when the operation signal indicates an operation content for enabling the noise canceling function, the left function control circuit 179 puts, in operation, the left ANC circuit 177 directly or via the left mode circuit 175, and causes the left ANC circuit 177 to transmit a canceling signal to the left signal processing circuit 172. Further, for example, when the operation signal indicates an operation content for enabling the hear-through function, the left function control circuit 179 puts, in operation, the left amplification circuit 176 directly or via the left mode circuit 175, and causes the left amplification circuit 176 to transmit an amplification signal to the left signal processing circuit 172.

The left sound emitting unit 10 removed from the charger 30 is worn in the user's left ear in a state of in which the left sound emitting unit 10 operates in the first operating mode. As described above, since the left sound emitting unit 10 has a size to an extent that fits in an auricle, the left control switch 14 of the left sound emitting unit 10 is small and an operation method also needs to be simple. The user operates the left control switch 14 of the left sound emitting unit 10 close to the ear without visually checking the left sound emitting unit 10, and thus accidental operation may also occur. In the present embodiment, when the left sound emitting unit 10 is worn in the left ear, the operating mode of the left sound emitting unit 10 is the operation disabled mode, and the operation of the left control switch 14 is disabled, and thus the left sound emitting unit 10 is worn in the left ear without accidental operation.

Note that, in the present embodiment, when the control switch is a touch sensor, an operation is performed by the user only touching the touch sensor during wearing in the ear. Contact with the touch sensor causes accidental operation. Thus, particularly when the control switch is the touch sensor, the earphone device according to the present embodiment is effective.

An operation of the right sound emitting unit 20 is common to the operation of the left sound emitting unit 10. Thus, also in the right sound emitting unit 20, the operation of the right control switch 24 is disabled until the standby time is elapsed since the right sound emitting unit 20 is removed from the charger 30.

Note that switching of the operating modes in the left and right sound emitting units may be simultaneously performed. In this case, for example, the operating modes of the left and right sound emitting units may be switched after a lapse of the standby time described in the first embodiment and the second embodiment.

### Conclusion (3)

According to the embodiment described above, the left sound emitting unit 10 (right sound emitting unit 20) includes the left control switch 14 (right control switch 24) that controls the operation of the left sound emitting unit 10 (right sound emitting unit 20). The operating function of the left control switch 14 (right control switch 24) is disabled in the first operating mode and is enabled in the second operating mode. According to this configuration, when the left sound emitting unit 10 (right sound emitting unit 20) is worn in the user's ear, the operating function of the left control switch 14 (right control switch 24) is disabled, and thus the user can wear the left sound emitting unit 10 (right sound emitting unit 20) in the ear without accidental operation. When the user wears the left sound emitting unit 10 (right sound emitting unit 20) in the ear, there is no accidental operation, and thus the user does not feel stressed. Further, since the operating mode of the left sound emitting unit 10 (right sound emitting unit 20) is automatically switched to the second operating mode at a timing of wearing, a desired function is put in operation without making the user feel stressed.

Note that, in the present invention, the standby time (predetermined time) is not limited to the time in the present embodiment. That is, for example, the time in the present invention may be set according to the time until the user wears the sound emitting unit.

Further, in the present invention, the first embodiment (second embodiment) and the third embodiment are described as the different embodiments, but may be combined together. For example, after the switching of the operating mode in the first embodiment (second embodiment) ends, the switching of the operating mode in the third embodiment may be performed. On the contrary, after the switching of the operating mode in the third embodiment ends, the switching of the operating mode in the first embodiment (second embodiment) may be performed.

Furthermore, in the present invention, a flow of power and a flow of a signal in each embodiment are one example, and the present invention is not limited to the flow of power and the flow of a signal in each embodiment.

### REFERENCE SIGNS LIST

1 Present device (Earphone device)
10 Left sound emitting unit (Sound emitting unit, First sound emitting unit)
14 Left control switch (Control interface)
16 Left driver unit (Driver unit)
171 Left reception circuit (Antenna)
173 Left transmission/reception circuit (First communication unit)
18 Left battery (Battery)
20 Right sound emitting unit (Sound emitting unit, Second sound emitting unit)
24 Right control switch (Control interface)
26 Right driver unit (Driver unit)
271 Right reception circuit (Antenna)
273 Right transmission/reception circuit (Second communication unit)
28 Right battery (Battery)
30 Charger

1. An earphone device comprising a sound emitting unit configured to be worn in an ear of a user, wherein
the sound emitting unit includes:
an antenna configured to receive an audio signal;
a driver unit configured to be driven based on the audio signal received by the antenna; and
a battery configured to store power supplied to the antenna, the battery is charged when the sound emitting unit is accommodated in a charger, the sound emitting unit
is in an inactive state when the sound emitting unit is accommodated in the charger, and
is in an active state when the sound emitting unit is not accommodated in the charger,
an operating mode of the sound emitting unit in the active state includes
a first operating mode, and
a second operating mode, and,
when a state of the sound emitting unit is switched from the inactive state to the active state, the operating mode of the sound emitting unit for a predetermined time after the switching is the first operating mode.

2. The earphone device according to claim 1, wherein, when a state of the sound emitting unit is switched from the inactive state to the active state and after the predetermined time has elapsed after the switching, the operating mode of the sound emitting unit is the second operating mode.

3. The earphone device according to claim 1, wherein
the sound emitting unit includes a control interface configured to control an operation of the sound emitting unit, and
an operating function of the control interface
is disabled in the first operating mode, and
is enabled in the second operating mode.

4. The earphone device according to claim 1, wherein
the sound emitting unit includes
a first sound emitting unit configured to be worn in one ear of the user, and
a second sound emitting unit configured to be worn in another ear of the user, and,
when the first sound emitting unit is switched to the active state while the first sound emitting unit and the second sound emitting unit are in the inactive state, the operating mode of the first sound emitting unit is the first operating mode until the second sound emitting unit is switched to the active state.

5. The earphone device according to claim 4, wherein, after the second sound emitting unit is switched to the active state and then the predetermined time has elapsed, the operating mode of the first sound emitting unit operating in the first operating mode is switched to the second operating mode.

6. The earphone device according to claim 5, wherein
the sound emitting unit has a noise canceling function,
the noise canceling function is disabled in the first operating mode, and
the noise canceling function is enabled in the second operating mode.

7. The earphone device according to claim 6, wherein
the sound emitting unit has a hear-through function,
the hear-through function is enabled in the first operating mode, and
the hear-through function is disabled in the second operating mode.

8. The earphone device according to claim 5, wherein the predetermined time is determined based on an elapsed time from a moment at which the first sound emitting unit is switched from the inactive state to the active state to a moment at which the second sound emitting unit is switched from the inactive state to the active state.

9. The earphone device according to claim 5, wherein
the first sound emitting unit includes a first communication unit configured to communicate with the second sound emitting unit,
the second sound emitting unit includes a second communication unit configured to communicate with the first sound emitting unit, and
the predetermined time is determined based on a moment at which the first communication unit is notified by the second communication unit that the second sound emitting unit is in the active state.

10. The earphone device according to claim 5, wherein the operating mode of the second sound emitting unit switched from the inactive state to the active state is switched from the first operating mode to the second operating mode when the first sound emitting unit is switched from the first operating mode to the second operating mode.
